(19) United States
(12) Patent Application Publication
(10) Pub. No.: US 2015/0056482 A1
(43) Pub. Date: Feb. 26, 2015

(54) BATTERY PACK WITH A FIRE PREVENTING AGENT

(71) Applicants: Jyri Kyla-Kaila, Naantali (FI); Pia Sjoberg-Eerola, Turku (FI); Lasse Kopra, Vinkkila (FI); Panu Kanniainen, Uusikaupunki (FI)

(72) Inventors: Jyri Kyla-Kaila, Naantali (FI); Pia Sjoberg-Eerola, Turku (FI); Lasse Kopra, Vinkkila (FI); Panu Kanniainen, Uusikaupunki (FI)

(73) Assignee: Valmet Automotive Oy, Uusikaupunki (FI)

(21) Appl. No.: 14/395,682

(22) PCT Filed: Apr. 24, 2012
(86) PCT No.: PCT/FI2012/050402

§ 371 Date: Oct. 20, 2014

(51) Int. Cl. H01M 10/658; H01M 10/0525; H01M 10/625

(52) U.S. Cl. CPC H01M 10/5087; H01M 10/5016; H01M 10/0525; H01M 2220/20; H01M 2200/10
USPC 429/61

(57) ABSTRACT

A battery pack having one or more battery cells, a shell enclosing the one or more battery cells, wherein at least part of the shell is separated in space with one or more battery cells, and a fire preventing and restricting agent placed between the shell and one or more battery cells. The fire preventing and restricting agent includes thermally expandable agent which is capable of preventing, retarding and/or extinguishing a fire in the battery pack by filling the space between the shell and one or more battery cells.

### FIELD OF THE INVENTION

The present invention relates to batteries and battery packs. More specifically, the invention relates to battery packs with fire preventing and restricting agents.

### BACKGROUND OF THE INVENTION

Batteries are used in a wide variety of electric devices from cell phones and laptops to electric cars. In order to obtain higher powers, batteries can be stacked to form a battery pack which typically contains from several cells to over 10 cells connected in series or in parallel.

During charging and discharging of batteries, their temperature may rise. If the heat cannot dissipate from the batteries sufficiently, the batteries may catch fire or explode. If a battery has been damaged and/or deformed, the risk of ignition or explosion is even higher. This problem is especially relevant in the field of electric vehicles, wherein high-power Lithium-ion (Li-ion) batteries are currently used.

In case of Li-ion batteries, the battery cells consist of current collectors (Al, Cu) coated with a material of a composition depending on the Li-ion battery type and the electrode (anode, cathode). There is electrolyte between the electrodes which in Li-ion battery cells is organic carbonate. The electrodes are further separated from each other by a separator membrane through which the ions are able to pass. It is usually desirable to increase the active surface area of the electrodes by making the material very fine, i.e. to reduce the particle size of the material. However, it has been noted that as the battery is being used, the particles undergo agglomeration, i.e. the particle size starts to grow. At the worst, this may lead for example to the breakage of the separator membrane and to a short circuit inside the cell. Such a situation is also possible for example as impurity metal particles sometimes present in the cells break the separator membrane. Possible scenarios after an internal short circuit are for example ignition of the organic carbonate used as electrolyte, internal overpressure in the battery cell due to quick rising of the temperature and explosion of the battery cell or melting of the battery cell due to a slower rise of the temperature in the battery cell whereby the organic carbonate may leak out of the cell.

Fire protection of the battery pack is therefore a very important safety-affecting factor. As an example of active temperature regulation, air cooling of the batteries by blowers and liquid cooling by an external liquid circulation system have been used in the prior art. These techniques, however, are not very efficient against li-ion battery fires. They also require lots of space which is not desirable for a battery that's used in a vehicle or an electronic device.

Another example of prior art solutions is disclosed in DE 102008059948 which teaches the use of a fire-extinguishing agent storage connected to a li-ion battery by an emergency line. This line has an emergency opening which allows introduction of the fire-extinguishing agent in case of fire. In this solution, it is necessary to create space for an external pressurized container connected to the battery which may not be suitable in many applications.

In other known techniques, such as the one disclosed in US 2011064997, the housing of a car battery may include an ionomer that forms a self-sealing barrier around the electrochemical cells in the interior. However, a modified housing of the battery involves certain manufacturing complications and restrictions as to which material is used as a housing. In another prior art solution, shown in WO 2012022479, walls of the housing are coated or impinged on with an extinguishing agent or an extinguishing agent additive to prevent fires in a battery.

Both these prior art techniques involve using a fire-extinguishing agent that prevents the fire from spreading outside the battery. However, the problem of the battery cells gradually heating up and possibly melting or catching a fire and then exploding is not addressed in these solutions.

Therefore, an object of the present invention is to alleviate the problems described above.

### SUMMARY OF THE INVENTION

A first aspect of the present invention is a battery pack, comprising one or more battery cells, a shell enclosing the one or more battery cells, wherein at least part of the shell is separated in space with said one or more battery cells, and a fire preventing and restricting agent placed between the shell and said battery cells. It is characterized in that the fire preventing and restricting agent comprises a thermally expandable agent which is capable of preventing, retarding and/or extinguishing a fire in the battery pack by filling the space between the shell and said one or more battery cells.

The at least part of the shell being separated in space with the battery cells means that there is space between them, and the fire preventing and restricting agent is placed in this space.

A fire preventing and restricting agent is a substance that can be used for preventing a fire in a battery pack, retarding it or restricting its spreading.

By thermally expandable agent is meant an agent that expands upon rising of the temperature of its surroundings, e.g. when the battery pack overheating.

An advantage of the invention is that the battery does not need any additional added or removable parts like e.g. an external storage. Outer cover insulation is replaced by a much more efficient internal agent that expands in case of fire. Since the invention is a passive safety solution, it does not require any extra serviceable parts.

Another advantage of the present invention is that it does not contain Br compounds or other toxic compounds which are generally used in flame retardants.

Also, since the fire preventing and restricting agent is placed in the space between the shell and the battery cells, and some space is left for its possible expansion in case of fire, there is a possibility to provide air or liquid cooling throughout this remaining space in normal battery operation mode.

A further advantage of the present invention is that the thermally expandable agent responds to temperature rises in the battery pack in the most efficient manner. This means it is not necessary that the battery cells are actually on fire or melting for the agent to start expanding. I.e. if the cells are overheating, the thermally expandable agent can expand in response to this. It will seal the heated area from outside oxygen and prevent transfer of heat, providing a preventive measure and serving as a fire retardant. On the other hand, if the battery cells still ignite, the thermally expanding agent isolates the interior of the burning battery, thereby extinguishing the fire in the cells. It also efficiently blocks combustion gases from spreading and fills cracks if the shell of the battery is broken.

In an embodiment of the invention, the thermally expandable agent is thermally expandable graphite. By expandable graphite is meant graphite, a graphite salt or a graphite intercalation compound that increases in volume in response to outer heat. An example of this material is the expandable graphite presented by GK™ (manufacturer Graphit Krophfmühl AG, Germany).

In an embodiment of the invention, the at least one battery cell of the battery pack is a Lithium-ion battery cell. These cells have been shown to catch fires in case of damage and for reasons explained above. They are also the most widely used battery cells in many industries.

In an embodiment of the invention, the battery pack is a battery pack of an electric vehicle. Safety is an especially important factor in electric vehicles, and a situation where a high-power battery pack of such vehicle is damaged can easily occur in a car accident.

In an embodiment of the invention, the fire preventing and restricting agent of the battery pack is applied to the inner surface of the shell. This enables better cooling of the cells in normal operation of the battery pack.

In an embodiment of the invention, the thermally expandable agent substantially encapsulates the one or more battery cells. In other words, the fire preventing and restricting agent comprising thermally expandable agent substantially covers the whole inner surface of the shell or the whole surface of the battery cells. In this embodiment, the thermal expansion is certain to start at the place nearest to the heating or ignition area of the battery cells. This provides higher efficiency of heat management.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrates an embodiment of the invention and together with the description helps to explain the principles of the invention.

FIG. 1 is a cross-section of a battery pack according to one embodiment of the present invention, and

FIG. 2 shows the battery pack of FIG. 1 in a state wherein the thermally expandable agent has filled the space between the shell and battery cells.

### DETAILED DESCRIPTION OF THE INVENTION

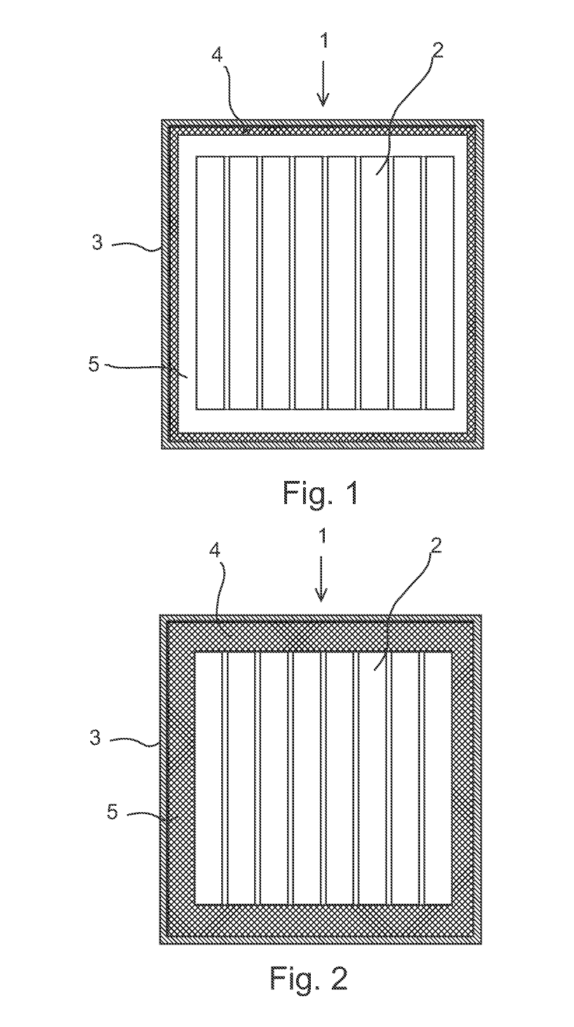

FIG. 1 shows a battery pack 1 according to the present invention. In this embodiment, there is a plurality of individual battery cells 2 in the battery pack, the battery pack shell 3 is separated in space from the cells 2, and the fire preventing and restricting agent 4 is applied to the inner surface of the battery pack shell 3. As can be seen on FIG. 1, there is an empty space 5 left between the agent 4 and the battery cells 2. This figure shows the battery pack in normal operation. The space 5 can be used for air cooling or liquid cooling of the battery cells. The fire preventing and restricting agent 4 comprises thermally expandable graphite. The purpose of this agent 4 is to prevent a fire or melting of the cells 2 by isolating the heated cells from the environment by expanding and sealing them. This way the toxic combustion gases are also prevented from spreading outside the battery.

Referring to FIG. 2, in an exemplary embodiment, when the temperature of the battery cells 2 rises above a pre-determined critical temperature limit, the thermally expandable agent of the fire preventing agent 4 starts to expand and fill the empty space 5 inside the battery pack 1. This prevents the fire from starting by sealing the cells 2. In case the fire has started, it blocks any air supply to the ignited area and thereby smothers the fire. It also blocks toxic combustion gases from spreading outside the battery pack 1 because in this example the fire preventing and restricting agent 4 entirely encapsulates the battery cells 2.

Although the invention has been the described in conjunction with a certain type of a battery pack, it should be understood that the invention is not limited to any certain type of batteries or battery packs. While the present inventions have been described in connection with a number of exemplary embodiments and implementations, the present inventions are not so limited, but rather cover various modifications, and equivalent arrangements, which fall within the purview of prospective claims.

1. A battery pack, comprising:
one or more battery cells,
a shell enclosing the one or more battery cells, wherein at least part of the shell is separated in space with said one or more battery cells, and
a fire preventing and restricting agent placed between the shell and said one or more battery cells, so that the battery cells are encapsulated by said fire preventing and restricting agent, characterized in that the fire preventing and restricting agent comprises thermally expandable agent; and that the fire preventing and restricting agent is applied to the inner surface of the shell so that an empty space is left between the fire preventing and restricting agent and the battery cells for the provision of air or liquid cooling in said space in normal battery operation mode, said thermally expandable agent being capable of preventing, retarding and/or extinguishing a fire in the battery pack by expanding and filling the space between the shell and said one or more battery cells in response to overheating of the cells.

2. The battery pack of claim 1, characterized in that the thermally expandable agent is thermally expandable graphite.

3. The battery pack of claim 1, characterized in that the at least one battery cell is a Lithium-Ion battery cell.

4. The battery pack of claim 1, characterized in that the battery pack is a battery pack of an electric vehicle.

5. The battery pack of claim 2, characterized in that the at least one battery cell is a Lithium-Ion battery cell.

6. The battery pack of claim 2, characterized in that the battery pack is a battery pack of an electric vehicle.

7. The battery pack of claim 3, characterized in that the battery pack is a battery pack of an electric vehicle.
